(19) United States
(12) Patent Application Publication
(10) Pub. No.: US 2026/0357988 A1
(43) Pub. Date: Nov. 12, 2026

(54) NOZZLE DEVICE, COMBUSTION CHAMBER ARRANGEMENT WITH A NOZZLE DEVICE, AND ENGINE

(71) Applicant: Rolls-Royce Deutschland Ltd & Co KG, Blankenfelde-Mahlow (DE)

(72) Inventors: Carsten CLEMEN, Mittenwalde (DE); Ruud EGGELS, Berlin (DE)

(21) Appl. No.: 19/668,095

(22) Filed: May 5, 2026

(30) Foreign Application Priority Data
May 6, 2025 (DE) 10 2025 117 314.1

(51) Int. Cl. F23R 3/36; B64D 27/10; F02C 7/22; F23C 1/08; F23D 14/58; F23R 3/60

(52) U.S. Cl. CPC F23R 3/36; B64D 27/10; F02C 7/22; F23C 1/08; F23D 14/58; F23R 3/60; F23C 2900/9901; F23R 2900/03043

(57) ABSTRACT

A nozzle arrangement for introducing gaseous fuel, in particular containing hydrogen, and liquid fuel into a combustion chamber of a gas turbine of an aircraft, having a downstream nozzle main body oriented along a burner axis, including a liquid nozzle arrangement for feeding the liquid fuel to the combustion chamber, an upstream flange for mounting the nozzle arrangement on an outer housing, and having a shaft running between the flange and the nozzle main body, wherein a liquid feed line for conducting the liquid fuel runs in the shaft. An assembly-friendly nozzle arrangement is provided in that a gas feed line for conducting the gaseous fuel furthermore runs in the shaft, and in that the nozzle arrangement includes at least one gas nozzle device with a main body portion which is separate from the nozzle main body and is oriented along a nozzle axis.

This application claims priority to German Patent Application 10 2025 117 314.1 filed May 6, 2025, the entirety of which is incorporated by reference herein.

The invention relates to a nozzle arrangement for introducing gaseous fuel, in particular containing hydrogen, and liquid fuel into a combustion chamber of a gas turbine of an aircraft, having a downstream nozzle main body oriented along a burner axis, comprising a liquid nozzle arrangement for feeding the liquid fuel to the combustion chamber, an upstream flange for mounting the nozzle arrangement on an outer housing, and having a shaft running between the flange and the nozzle main body, wherein a liquid feed line for conducting the liquid fuel runs in the shaft. The invention furthermore relates to a combustion chamber arrangement having a nozzle arrangement, and to an engine.

A nozzle arrangement of this type is known from DE 10 2023 204 572 A1. In this case, the nozzle arrangement comprises a first injector group for introducing a liquid fuel and a second injector group for introducing a gaseous fuel. By means of the second injector group, a combustion chamber arrangement according to the prior art, which is designed exclusively for operation with liquid fuel, can be developed in a simple manner with regard to the (additional) operation with hydrogen. Challenges arise here when integrating the second injector group, in particular with regard to the installation space and/or the assembly.

Combustion chamber arrangements for operation with hydrogen as fuel are known from DE 10 2005 048 815 A1, DE 10 2022 208 339 A1, US 2023/0408098 A1, DE 10 2022 201 182 A1 and US 2024/0318822 A1.

The invention is based on the object of providing an assembly-friendly nozzle arrangement of the type mentioned at the beginning, and a corresponding combustion chamber arrangement, and a corresponding engine.

This object is achieved for the nozzle arrangement with the features of claim 1, for the combustion chamber arrangement with the features of claim 11, and for the engine with the features of claim 15.

In the case of the nozzle arrangement, it is provided that a gas feed line for conducting the gaseous fuel furthermore runs in the shaft, and in that the nozzle arrangement comprises at least one gas nozzle device with a main body portion which is separate from the nozzle main body and is oriented along a nozzle axis.

A gas fuel line of the gas nozzle device runs through the gas feed line and the main body portion.

The main body portion refers to that portion which is oriented at least substantially along the nozzle axis. Slight angular deviations, for example by up to 40° or by up to 10° or 20°, from the nozzle axis can be present upstream of the downstream end portion.

Thus, the gas nozzle device has the main body portion separate from the nozzle main body and a shaft portion formed by the gas feed line. The shaft portion is integrated in the shaft of the nozzle arrangement, at the downstream end of which the nozzle main body with the liquid nozzle arrangement is arranged.

Thus, a nozzle device known, for example, from the prior art and initially designed exclusively for the addition of liquid fuel is developed in a simple manner by partial integration of the gas nozzle device, thus forming the nozzle arrangement according to the invention. It is thus possible, with comparatively low structural outlay, to provide a nozzle arrangement which is designed both for the (simultaneous and/or separate) operation with liquid fuel and for operation with gaseous fuel and can be integrated in a combustion chamber arrangement in a simple and space-saving manner.

The liquid nozzle arrangement has, in particular, an atomizer arrangement for atomizing the liquid fuel. In particular, the nozzle main body does not have a gas nozzle.

The shaft preferably runs rectilinearly, along a single axis between the flange and the nozzle main body.

In an expedient embodiment variant, it is provided that the gas nozzle device has a pipeline, in particular is formed therefrom, and preferably does not comprise an air duct (which is separate and is independent of the liquid nozzle arrangement). In particular, the pipeline forms the main body portion. A portion of a gas fuel duct arranged in the main body portion or in the pipeline and adjoining the portion in the gas feed line has in particular a cylindrical flow cross section.

In one embodiment variant, in particular comprising one single gas nozzle device per nozzle main body, it is preferably provided that the gas feed line (forming the shaft portion) merges directly into the main body portion, without the interposition of another line structure and/or another line portion. In this case, the gas fuel duct changes in particular its profile direction from a substantially radial orientation (with respect to a central axis of the combustion chamber arrangement) in the region of the shaft portion or of the gas feed line into an orientation in the region of the main body portion running substantially along the nozzle axis.

In one embodiment variant, in particular comprising more than one gas nozzle device per nozzle main body, it is preferably provided that a gas plenum, in particular arranged in an annular element around the nozzle main body, is arranged between the gas feed line and the main body portion. The annular element is preferably arranged on an upstream portion of the nozzle main body. In this case, in particular, the shaft can be fastened to the annular element and the nozzle main body can be fastened within the annular element by means of same. In particular, the gas plenum is designed to run annularly around the nozzle main body and forms a common supply space for all of the gas nozzle devices assigned to the relevant nozzle main body. In this way, the gaseous fuel can be distributed uniformly to a plurality of gas nozzle devices.

For the mechanical protection of the main body portion, it can be advantageously provided that an enveloping device is at least partially arranged around the main body portion (preferably between the shaft and the front plate). The enveloping device can be in contact with the pipeline in a radially encircling manner.

For an advantageous integration and/or an advantageous operation, it can be provided that the main body portion is at least partially arranged, in particular at its downstream end, at a radial distance from the nozzle main body (with respect to the burner axis). A distance (between the outer walls of the nozzle main body and the main body portion) may correspond, for example, to at least one cross-sectional dimension (e.g. a diameter) of the main body portion. In this way, in addition to the nozzle main body, the gas nozzle device or devices can also be integrated radially and in the circumferential direction at an advantageous position in the front plate of the burner arrangement.

In support of an advantageous operation, the nozzle arrangement can have, at its downstream end, a nozzle tip which is narrowed, in particular conically, with a constricted flow cross section.

Advantages for the combustion operation result if the main body portion with the nozzle axis
is oriented parallel to the burner axis of the nozzle main body or
inclined in the direction of the burner axis, for example in such a way that, in the assembled state, the burner axis and the nozzle axis intersect axially level with one of the mixing air openings of a combustion chamber (with respect to the radial direction and/or the circumferential direction).

In particular in this context, it can advantageously be provided that the burner axis and the nozzle axis/axes are spaced apart from one another in such a way that, in the assembled state on a combustion chamber arrangement having mixing air openings, the nozzle main body and/or the main body portion is/are arranged at the same position in the circumferential direction as in each case one of the mixing air openings.

Preferred embodiment variants consist in that the nozzle main body is assigned in each case at least one, for example precisely one, precisely two, precisely three or precisely four gas nozzle devices, i.e. the gas supply line and the liquid supply line are integrated in a common shaft, the shaft of the nozzle main body. In the assembled state on a combustion chamber arrangement in the form of an annular combustion chamber, the gas nozzle device(s) is/are arranged (with their nozzle axis/axes) with respect to a central axis thereof,
in the case of precisely one gas nozzle device, radially on the outside with respect to the burner axis and circumferentially at the same position as the burner axis,
in the case of precisely two gas nozzle devices, radially at the same position as the burner axis and offset circumferentially with respect to the burner axis and preferably equidistantly with respect to the burner axis,
in the case of precisely three gas nozzle devices, two thereof radially on the outside with respect to the burner axis and one on the inside with respect to the burner axis and preferably equidistantly with respect to the burner axis and/or with respect to one another, and/or
in the case of precisely four gas nozzle devices, two thereof radially at the same position as the burner axis and offset circumferentially with respect to the burner axis, and two radially on the outside and inside with respect to the burner axis and circumferentially at the same position, and preferably equidistantly with respect to the burner axis and/or with respect to one another, and/or
in the case of precisely four gas nozzle devices, two thereof radially on the outside and two radially on the inside, and in each case offset circumferentially with respect to the burner axis, and preferably equidistantly with respect to the burner axis and/or with respect to one another.

The combustion chamber arrangement according to the invention has a combustion chamber, comprising an inlet-side front plate with a heat shield arranged flat on the front plate on the combustion chamber side, combustion chamber walls for delimiting a combustion chamber, and at least one nozzle arrangement according to one of the preceding claims, the nozzle arrangement being oriented along a burner axis, having a nozzle main body for the addition of liquid fuel and having a gas nozzle device for the addition of gaseous fuel, in particular containing hydrogen, via the front plate with the heat shield into the combustion chamber.

The combustion chamber can in particular be designed so as to annularly encircle a central axis and can have a plurality of sectors, wherein, in particular per sector, one front plate for forming a coherent front plate arrangement is arranged on the inlet side of the combustion chamber.

It can advantageously be provided that a plurality of cooling air openings are arranged in the heat shield in each case annularly around the gas nozzle device, said cooling air openings being designed in such a way that a cooling air jet in each case passing through them is oriented (with respect to its main flow direction during operation) so as to flow parallel or radially outwards.

The nozzle arrangement can advantageously be integrated if the gas nozzle device is mounted in a floating manner on the front plate, in particular in the heat shield, on the downstream side, optionally in each case with a sealing device. In this way, axial play is possible, for example for compensating for thermal expansion at the combustion chamber arrangement during operation.

An assembly-friendly embodiment variant consists in that a hood is not located upstream of the front plate.

The invention will be explained in more detail in the following text by way of exemplary embodiments with reference to the drawings, in which:

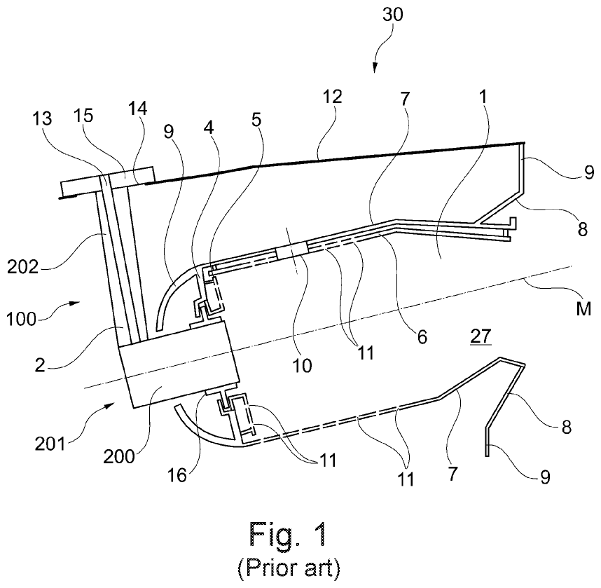

FIG. 1 shows a schematic illustration of a combustion chamber arrangement according to the prior art, having a liquid fuel nozzle, in longitudinal section,

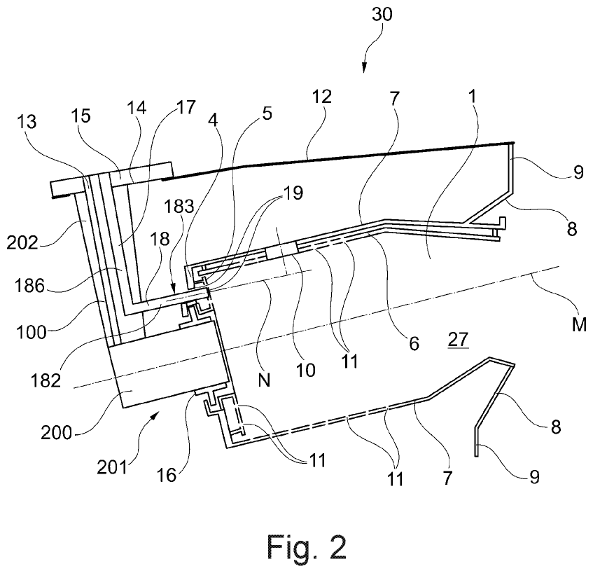

FIG. 2 shows a schematic illustration of a combustion chamber arrangement according to the invention, having a nozzle arrangement comprising a nozzle main body for the addition of liquid fuel, and a gas nozzle device, in longitudinal section,

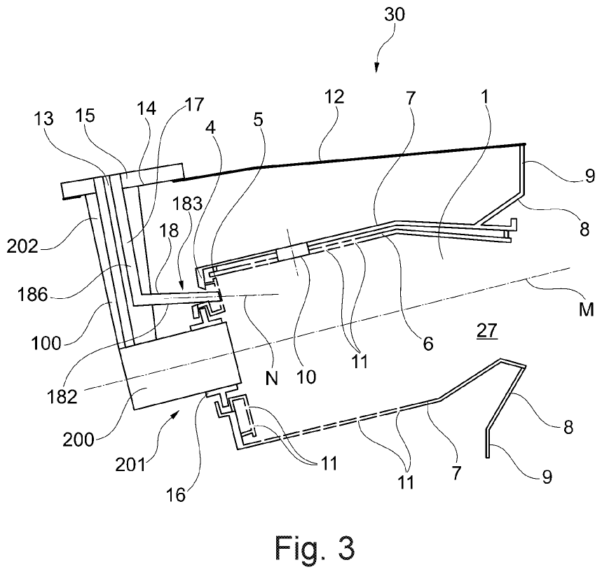

FIG. 3 shows a schematic illustration of a further embodiment variant of the combustion chamber arrangement according to the invention in longitudinal section,

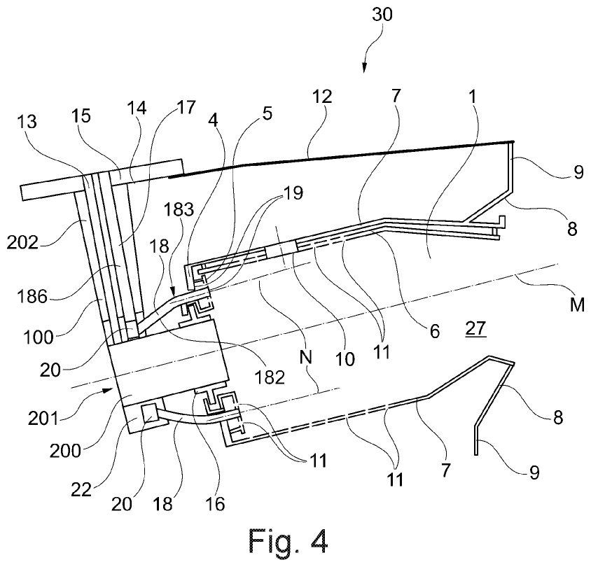

FIG. 4 shows a schematic illustration of a further embodiment variant of the combustion chamber arrangement according to the invention in longitudinal section,

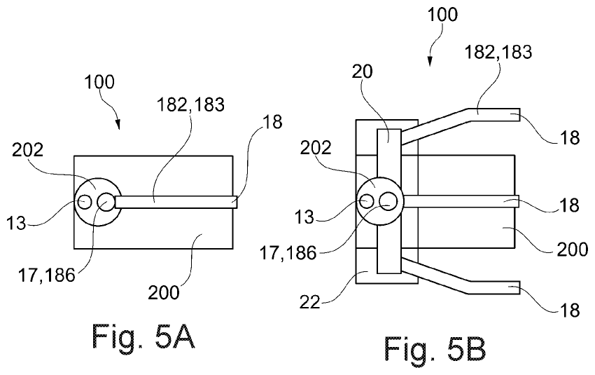

FIGS. 5A, 5B each show a schematic illustration of an embodiment variant of a nozzle arrangement according to the invention, having a shaft in cross section with a top view of a nozzle main body,

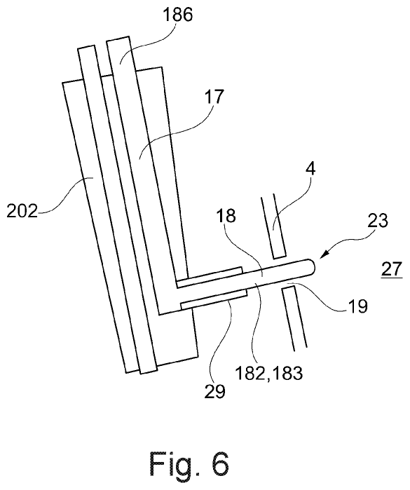

FIG. 6 shows a schematic illustration of a gas nozzle device of the nozzle arrangement in longitudinal section,

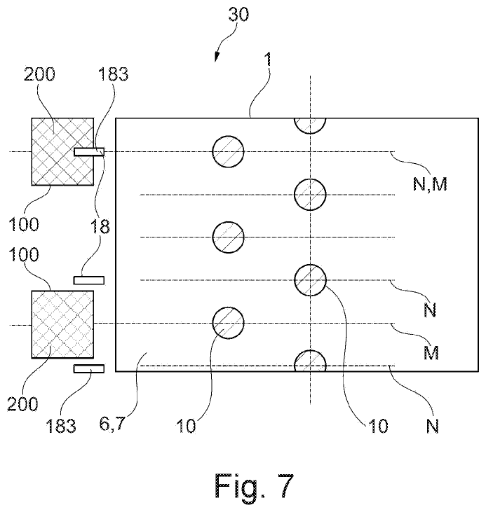

FIG. 7 shows an embodiment variant of the combustion chamber arrangement comprising mixing air openings, in a schematic illustration in top view,

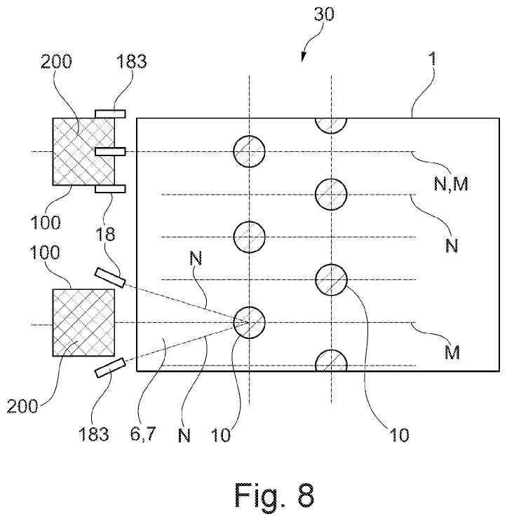

FIG. 8 shows a further embodiment variant of the combustion chamber arrangement comprising mixing air openings, in a schematic illustration in top view,

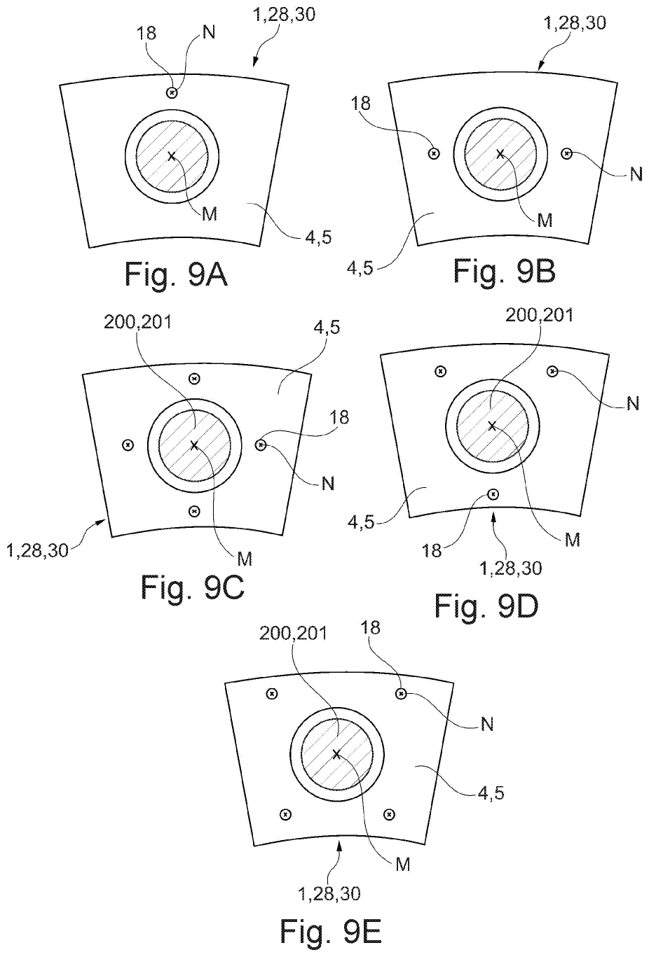

FIGS. 9A-9E show schematic illustrations of front plates in top view, with different positions of the gas nozzle device(s),

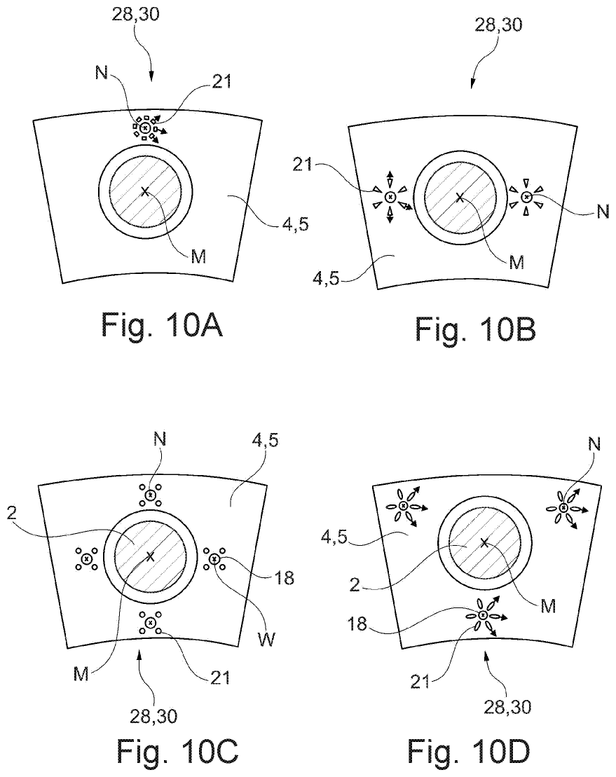

FIGS. 10A-10D show schematic illustrations of front plates in top view, with the different positions of the gas nozzle device(s), and cooling air openings arranged around the gas nozzle device, and

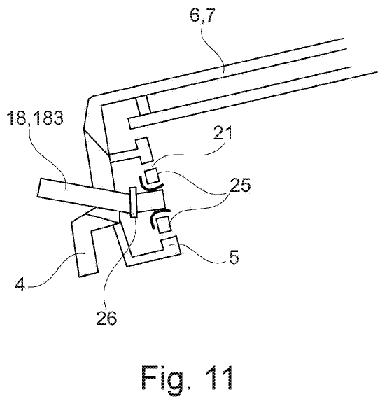

FIG. 11 shows a detail of a part of the combustion chamber arrangement according to the invention, with the integration of the nozzle device in a front plate.

FIG. 1 schematically shows, in a longitudinal section, an exemplary combustion chamber arrangement 30 known from the prior art, wherein a combustion chamber 1, surrounded by an outer housing 12, is integrated in an aircraft engine (not shown completely here). The combustion chamber 1 comprises an inlet-side front plate 4, on which a heat shield 5 is arranged on the combustion chamber side. Furthermore, the combustion chamber 1 comprises at least one outer combustion chamber wall 7 and, optionally, an inner combustion chamber wall 6, which may be designed as a shingle. The combustion chamber walls 6, 7 circumferentially delimit a combustion chamber 27. Mixing air openings 10 may be arranged within the combustion chamber walls 6, 7. For cooling, the combustion chamber walls 6, 7 and preferably the heat shield 5 on the front plate 4 comprise a multiplicity of cooling air openings 11.

The combustion chamber 1 is mounted at its downstream end by means of a combustion chamber mount 8 and a combustion chamber flange 9.

On the upstream side of the front plate 4, the combustion chamber 1 has, in particular, a hood 3, for flow-optimized air guidance.

Furthermore, the combustion chamber 1 comprises at least one liquid fuel nozzle 2 exclusively for the addition of liquid fuel into the combustion chamber 27. The liquid fuel nozzle 2 has a nozzle main body 200 which is oriented along a burner axis M and on which the liquid fuel nozzle 2 is mounted on the front plate 4 by means of a burner seal 16. In addition, the liquid fuel nozzle 2 has a shaft 202, in which a liquid feed line 13 is arranged. The liquid fuel nozzle 2 is fastened to the outer housing 12 by means of the shaft 202, which is guided through a suitable opening 14 in the outer housing 12, and by means of a flange 15 arranged outside the outer housing 12.

In the development of such a combustion chamber arrangement 1 with regard to the (additional) operation with hydrogen, as is known, for example, from DE 10 2023 204 572 A1, challenges arise in the integration of additional nozzles, in particular with regard to the installation space and/or the assembly.

FIG. 2 shows a combustion chamber arrangement 30 which is developed according to the invention, wherein, by way of example, precisely one additional, separate gas nozzle device 18, in particular in the form of a hydrogen nozzle, is integrated in a nozzle arrangement 100. Here, the nozzle arrangement 100 has, within the shaft 202, a liquid feed line 13 and a gas feed line 17 for conducting the gaseous fuel. The shaft 202 with the liquid feed line 13 and the gas feed line 17 runs in particular along a (rectilinear) axis between the flange 15 and the nozzle main body 200.

The opening 14 in the outer housing 12 and/or the flange 15 are preferably designed to be enlarged in relation to the known design shown in FIG. 1, in order to facilitate the assembly and to permit a stable construction.

Unlike the liquid feed line 13, the gas feed line 17 does not merge into the nozzle main body 200 but into a (separate) main body portion 183 of a gas nozzle device 18 that is different from the nozzle main body 200. The nozzle main body 200 is not designed for the addition of gaseous fuel into the combustion chamber 27.

The gas nozzle device 18 has the separate main body portion 183, which is oriented at least with a downstream portion along a nozzle axis N that differs from the burner axis M. In particular, the main body portion 183 is arranged at least with the downstream end or portion, preferably at a radial distance from the nozzle main body 200 over the entire length.

The main body portion 183 refers to that portion of the gas nozzle device 18 in which a gas fuel duct 186 is oriented at least substantially along the nozzle axis N. Slight angular deviations, for example by up to 40° or by up to 10° or 20°, with respect to the nozzle axis N can be present upstream of the downstream end.

The gas nozzle device 18 has a pipeline 182, which in particular forms the main body portion 183. The main body portion 183, in particular the pipeline 182, comprises exclusively the gas fuel duct 186 and no air duct. In the exemplary embodiment shown in FIG. 2, the gas feed line 17, as a shaft portion of the gas nozzle device 18, merges from the shaft 202 directly, without the interposition of another line structure and/or of another line portion, into the main body portion 183. Here, the gas feed line 17 is shorter than the liquid feed line 13. The nozzle axis N is oriented, for example, parallel to the burner axis M.

For an assembly-friendly design, the combustion chamber arrangement 30 does not have a hood 3.

The gas nozzle device 18 is guided through the front plate 4 with the heat shield 5 by means of separate openings 19.

FIG. 3 shows a further exemplary embodiment with the nozzle arrangement 100 according to the invention, wherein the main body portion 183 is oriented with the nozzle axis N inclined in the direction of the burner axis M at least with a radial directional component.

In comparison to the embodiment according to FIG. 3, FIG. 4 shows an embodiment variant of the nozzle arrangement 100 with at least two separate gas nozzle devices 18. Here, a circumferential annular element 22 is arranged at the downstream end of the nozzle main body 200, in which annular element a gas plenum 20, as a gas distribution chamber, is arranged preferably in an annular encircling manner. The gas feed line 17 opens into the gas plenum 20. For each gas nozzle device 18, in turn a main body portion 183 branches off from the gas plenum 20.

FIG. 5A and FIG. 5B each show cross-sectional views through the shaft 202 in a top view of the nozzle main body 200. FIG. 5A shows a variant with a gas nozzle device 18, without a gas plenum 20, for example in the embodiment according to FIG. 2 or FIG. 3. FIG. 5B shows a variant comprising the gas plenum 20 with at least three gas nozzle devices 18.

As FIG. 6 shows in a detailed illustration of the gas nozzle device 18, the gas nozzle device 18, in particular around the pipeline 182 thereof, can have an enveloping device 29 which is at least partially arranged around the main body portion 183 and serves for mechanical protection. The enveloping device can be in contact with the pipeline 182, for example.

Furthermore, the gas nozzle device 18 can have, at its downstream end, a nozzle tip 23 which is narrowed, in particular conically, with a constricted flow cross section, in order to accelerate the gas flow before it emerges into the combustion chamber 27.

FIG. 7 shows, in a schematic top view of the combustion chamber 1, two possible arrangement variants of the nozzle main body 200 and of the gas nozzle device 18 with respect to mixed air openings 10 arranged here by way of example on the combustion chamber 1. In this case, there are two rows of mixing air openings 10 arranged axially one behind the other, the mixing air openings 10 being arranged equidistantly from one another in each row and being at the same distance in both rows.

The mixing air openings 10 of both rows are each offset from the respective other row by half an opening distance in the circumferential direction.

The nozzle main body 200 is arranged in each case in the circumferential direction level with one of the mixing air openings 10. According to an embodiment variant shown at the top in FIG. 7, one of the gas nozzle devices 18 is arranged in the circumferential direction at the same position as the nozzle main body 200, likewise level with one of the mixing air openings 10.

According to a further embodiment variant, shown at the bottom in FIG. 7, two gas nozzle devices 18 are offset from the nozzle main body 200 on both sides in each case. In this case, the gas nozzle devices 18 with the nozzle axes N, that is to say with the main body portions 183, are arranged with respect to the circumferential direction level with the mixing air openings 10 respectively adjacent to the nozzle main body 200.

The burner axes M and the nozzle axes N are each aligned parallel to one another by way of example.

FIG. 8 shows, in a schematic top view of the combustion chamber 1, two further possible arrangement variants of the nozzle main body 200 and of the gas nozzle devices 18 with respect to one another and/or with respect to the mixed air openings 10. According to an embodiment variant shown at the top in FIG. 8, the nozzle arrangement 100 comprises three gas nozzle devices 18 in addition to the nozzle main body 200. A further fourth gas nozzle device 18, not illustrated here, may be present. One of the gas nozzle devices 18 is in the same position as the nozzle main body 200 in the circumferential direction, and the other two gas nozzle devices 18 are arranged on both sides of the nozzle main body 200 in the circumferential direction.

According to the second embodiment variant shown at the bottom in FIG. 8, two gas nozzle devices 18 are arranged, each on one side of the nozzle main body 200 in the circumferential direction. In the variant shown, the nozzle axes N are inclined with respect to the circumferential direction in the direction of the burner axis M of the nozzle main body 200 in such a way that the two nozzle axes N and the burner axis M intersect axially level with that mixing air opening 10 which is arranged in the circumferential direction at the position of the nozzle main body 200.

FIG. 9A, FIG. 9B, FIG. 9C and FIG. 9D illustrate four advantageous injection positions, wherein the combustion chamber 1 is configured in an annularly encircling manner around a central axis, as an annular combustion chamber (not illustrated completely here). In this case, the combustion chamber 1 has a plurality of sectors 28 in the circumferential direction, wherein preferably each sector 28 is assigned a front plate 4. FIG. 9A to FIG. 9D each show a top view of an exemplary embodiment of the front plate 4 comprising the heat shield 5 of a respective sector 28 of the combustion chamber 1. The combustion chamber 1 in the form of an annular combustion chamber has, in particular circumferentially, the same embodiment variant of the front plate 4.

In each of the exemplary embodiments, precisely one nozzle main body 200 with a liquid nozzle arrangement 201 is arranged in the center of the front plate 4. The position of the nozzle main body 200, and subsequently the positions of the gas nozzle devices 18, relate in each case to their central axes (burner axis M or nozzle axis N).

According to FIG. 9A, a preferred embodiment variant consists in that precisely one gas nozzle device 18 is present on the sector 28, which gas nozzle device is arranged radially on the outside and in a circumferential manner in relation to the central axis of the annular combustion chamber (not illustrated here) at the same position in relation to the nozzle main body 200.

According to FIG. 9B, a further preferred embodiment variant consists in that precisely two gas nozzle devices 18 are present on the sector 28, which gas nozzle devices are arranged radially at the same position with respect to the central axis and circumferentially offset in each case to one side (but not on a sector edge of the front plate 4) with respect to the nozzle main body 200 and preferably equidistantly thereto.

According to FIG. 9C, which represents a particularly preferred embodiment variant, precisely four gas nozzle devices 18 are present per nozzle main body 200, wherein two are arranged radially at the same position and circumferentially offset on both sides with respect to the nozzle main body 200, and two are offset with respect to one another radially above and below the nozzle main body 200, and are arranged circumferentially in the same position with respect to the nozzle main body 200. The gas nozzle devices 18 are preferably arranged equidistantly from the nozzle main body 200 and/or from one another.

According to FIG. 9D, a further preferred embodiment variant consists in that precisely three gas nozzle devices 18 are present on the sector 28, wherein one of the gas nozzle devices 18 is arranged radially on the outside and circumferentially in the same position, and two are arranged radially on the inside and offset on both sides with respect to the nozzle main body 200. The gas nozzle devices 18 are preferably arranged equidistantly from the nozzle main body 200 and/or from one another.

According to FIG. 9E, a further preferred embodiment variant consists in that precisely four gas nozzle devices 18 are present on the sector 28, each offset circumferentially with respect to the nozzle main body 200, wherein two of the gas nozzle devices 18 are arranged radially on the outside and two are arranged radially on the inside. The gas nozzle devices 18 are preferably arranged equidistantly from the nozzle main body 200 and/or from one another and/or from a sector edge.

FIG. 10A, FIG. 10B, FIG. 10C and FIG. 10D show the embodiment variants substantially according to FIG. 9A to FIG. 9D, wherein, in contrast thereto, a plurality of cooling air openings 21 are arranged in each case annularly around and equidistantly from the gas nozzle devices 18. Here, different exemplary shapes of the flow cross sections of the cooling air openings 21 are illustrated. The cooling air openings 21 are designed in such a way that a cooling air jet passing through them in each case emerges into the combustion chamber 27 in the main flow direction parallel or radially outward with respect to the nozzle axis N. The embodiment with the cooling air openings 21 is also possible in the case of an arrangement with four nozzle devices 18, as shown in FIG. 9E without cooling air openings 21.

FIG. 11 shows, in a detail in longitudinal section, one possible embodiment for integrating the gas nozzle device 18 in the front plate 4 with the heat shield 5. Here, a sealing device 25 for the floating mounting of the gas nozzle device 18 on the heat shield 5 is arranged on the downstream end portion of the main body portion 183, in a manner encircling the latter. For example, by means of an in particular encircling collar 26 on the gas nozzle device 18, which collar is arranged directly upstream of the heat shield 5 in the assembled state, the sealing device 25 is held in position on the heat shield 5 radially and/or in the circumferential direction. An axial movement is possible. During the assembly, the sealing device 25 is mounted on the heat shield 5 in particular axially from behind. For the at least temporary support during the assembly, the sealing device 25 may be temporarily adhesively bonded to the heat shield 5.

### LIST OF REFERENCE SIGNS

1 Combustion chamber
100 Nozzle arrangement
2 Liquid fuel nozzle
200 Nozzle main body
201 Liquid nozzle arrangement
202 Shaft
3 Hood
4 Front plate
5 Heat shield
6 Combustion chamber wall
7 Combustion chamber wall
   Combustion chamber
8 mount
   Combustion chamber
9 flange
10 Mixing air opening
11 Cooling openings
12 Outer housing
13 Liquid feed line
14 Opening
15 Flange
16 Burner seal
17 Gas feed line
18 Gas nozzle device
182 Pipeline
183 Main body portion
186 Gas fuel duct
19 Opening
20 Gas plenum
21 Cooling air opening
22 Annular element
23 Nozzle tip
24 Cooling opening
25 Sealing device
26 Collar
27 Combustion space
28 Sector
29 Enveloping device
   Combustion chamber
30 arrangement
M Burner axis
N Nozzle axis

1. A nozzle arrangement for introducing gaseous fuel, in particular containing hydrogen, and liquid fuel into a combustion chamber of a gas turbine of an aircraft, having a downstream nozzle main body oriented along a burner axis, comprising a liquid nozzle arrangement for feeding the liquid fuel to the combustion chamber, an upstream flange for mounting the nozzle arrangement on an outer housing, and having a shaft running between the flange and the nozzle main body, wherein a liquid feed line for conducting the liquid fuel runs in the shaft,
characterized in that a gas feed line for conducting the gaseous fuel furthermore runs in the shaft, and in that the nozzle arrangement comprises at least one gas nozzle device with a main body portion which is separate from the nozzle main body and is oriented along a nozzle axis.

2. The nozzle arrangement according to claim 1, wherein the gas nozzle device has a pipeline, in particular is formed therefrom, and preferably does not comprise an air duct.

3. The nozzle arrangement according to claim 1, wherein the gas feed line merges directly into the main body portion.

4. The nozzle arrangement according to claim 1, wherein a gas plenum, in particular arranged in an annular element around the nozzle main body, is arranged between the gas feed line and the main body portion.

5. The nozzle arrangement according to claim 1, wherein an enveloping device is at least partially arranged around the main body portion.

6. The nozzle arrangement according to claim 1, wherein the main body portion is at least partially arranged, in particular at its downstream end, at a radial distance from the nozzle main body.

7. The nozzle arrangement according to claim 1, wherein the nozzle arrangement has, at its downstream end, a nozzle tip which is narrowed, in particular conically.

8. The nozzle arrangement according to claim 1, wherein the main body portion with the nozzle axis
is oriented parallel to the burner axis of the nozzle main body or
inclined in the direction of the burner axis, for example in such a way that, in the assembled state, the burner axis and the nozzle axis intersect axially level with one of the mixing air openings of a combustion chamber.

9. The nozzle arrangement according to claim 1, wherein the burner axis and the nozzle axis/axes are spaced apart from one another in such a way that, in the assembled state on a combustion chamber arrangement having mixing air openings, the nozzle main body and/or the main body portion is/are arranged at the same position in the circumferential direction as in each case one of the mixing air openings.

10. The nozzle arrangement according to claim 1, wherein
in the case of precisely one gas nozzle device, radially on the outside with respect to the burner axis and circumferentially at the same position as the burner axis,
in the case of precisely two gas nozzle devices, radially at the same position as the burner axis and offset circumferentially with respect to the burner axis and preferably equidistantly with respect to the burner axis,
in the case of precisely three gas nozzle devices, two thereof radially on the outside with respect to the burner axis and one on the inside with respect to the burner axis and preferably equidistantly with respect to the burner axis and/or with respect to one another, and/or
in the case of precisely four gas nozzle devices, two thereof radially at the same position as the burner axis and offset circumferentially, and two radially on the outside and inside with respect to the burner axis and circumferentially at the same position, and preferably equidistantly with respect to the burner axis and/or with respect to one another, and/or
in the case of precisely four gas nozzle devices, two thereof radially on the outside and two radially on the inside, and in each case offset circumferentially with respect to the burner axis, and preferably equidistantly with respect to the burner axis and/or with respect to one another,
in that the nozzle main body is assigned in each case at least one, for example precisely one, precisely two, precisely three or precisely four gas nozzle devices which, in the assembled state on a combustion chamber arrangement in the form of an annular combustion chamber, is/are arranged with respect to a central axis thereof.

11. A combustion chamber arrangement having a combustion chamber comprising an inlet-side front plate with a heat shield arranged flat on the front plate on the combustion chamber side, combustion chamber walls for delimiting a combustion chamber, and at least one nozzle arrangement according to claim 1, wherein the nozzle arrangement being oriented along a burner axis, having a nozzle main body for the addition of liquid fuel and having a gas nozzle device for the addition of gaseous fuel, in particular containing hydrogen, via the front plate with the heat shield into the combustion chamber.

12. The combustion chamber arrangement according to claim 11, wherein a plurality of cooling air openings are arranged in the heat shield in each case annularly around the gas nozzle device, said cooling air openings being designed in such a way that a cooling air jet in each case passing through them is oriented so as to flow parallel or radially outwards.

13. The combustion chamber arrangement according to either of claim 11, wherein the gas nozzle device is mounted in a floating manner on the front plate, in particular in the heat shield, on the downstream side, optionally in each case with a sealing device.

14. The combustion chamber arrangement according to claim 11, wherein a hood is not located upstream of the front plate.

15. The engine for an aircraft having a combustion chamber arrangement according to claim 11.
